(19) United States
(12) Patent Application Publication
(10) Pub. No.: US 2007/0069019 A1
(43) Pub. Date: Mar. 29, 2007

(54) Economical, Efficient and Trustworthy Voting System

(76) Inventor: John Edmonds David, Fairfield, CT (US)

Correspondence Address: John Edmonds David, 25 Brett Road, Fairfield, CT, 06824-1718, US

(21) Appl. No.: 11/162,920

(22) Filed: Sep. 28, 2005

(51) Int. Cl. G07C 13/00

(52) U.S. Cl. 235/386

(57) ABSTRACT

We describe an economical and efficient voting system that uses paper balloting and statistical methods to allow trustworthy verification of the results. In the past, voting systems have relied on recounts to verify that the correct winner is chosen. However, recounts only prove the consistency of the system, doing little to prove that the choice of the winner is correct.

We describe an economical and efficient voting system that uses paper balloting and statistical methods to allow trustworthy verification of the results. In the past, voting systems have relied on recounts to verify that the correct winner is chosen. However, recounts only prove the consistency of the system, doing little to prove that the choice of the winner is correct.

We call a contest “trustworthy” if the winner correctly reflects the voters' choice. An example of a consistent but not trustworthy election contest is one in which the same results are always returned on recount but the incorrect winner is selected. For the first time, we provide a voting system in which it is possible to verify the trustworthiness of the results. As many computer security experts have noted, the current computer-based voting systems are not provably trustworthy.

There are degrees of trustworthiness, using the ratio of the number of contests where the correct winner is chosen divided by the number of contests. We provide a statistical test that determines the trustworthiness of a contest within a set level of confidence, which can easily be 99% or more.

We call a paper voting system “reliable” if the ballots are properly tabulated, that is, a properly marked vote for a contest is properly counted and an improperly marked vote for a contest is not counted. If a vote for a contest is properly tabulated, it is called an “effective vote,” otherwise it is called a “defective vote.” Note: according to our definition, an improperly marked vote that is not counted is called “effective”.

Our statistical test relies on the fact that a contest is trustworthy if one can show that when all defective votes for that contest have been made effective, the winner's total count is at most decreased by less than one-half the margin of victory.

There are degrees of reliability, using the ratio of the number of effective votes divided by the number of votes cast. For any particular contest, the degree of reliability does not have to be as high as the degree of trustworthiness. It only has to be high enough to ensure the defective votes, when made effective, do not reduce the margin of victory excessively. Thus one can generally be assured the correct winner has been chosen without all votes being effective or, equivalently, 100% reliability.

Our system is economical and fast in that it has minimal hardware requirements at the voting station level, requiring for the voter only a paper ballot, a marker and a table on which to write. A simple calculation shows this could allow for many more voting stations than a system that required expensive computer hardware at each voting station.

A modern office scanner costing $2500 is able to scan 30 votes per minute and one personal electronic voting station costing the same is able to process 30 votes per hour. Thus one scanner would have the same operating capacity as 60 (30*60/30) personal electronic voting stations, for the same cost. This implies the cost ratio of our proposed system to this hypothetical system of personal electronic voting stations is about 1:60. Thus for the same expenditure, a board of elections can have 60 times the capacity for voting, vastly reducing the average time a voter will have to wait in line. Furthermore, given the vastly reduced infrastructure and maintenance needed (one simple reliable machine to maintain versus 60 complex machines), this cost ratio drops even further.

This efficiency advantage allows our system to be potentially much faster in collecting the votes, compared to a system using a limited number of personal electronic voting stations. This should encourage more people to vote, knowing they would be spending less time waiting at the polling station. Also the trustworthy nature of our system will inspire confidence in the integrity of the voting system, again encouraging more people to vote. Finally, the simplicity of our system for the voters makes it again more attractive and encouraging for people to vote.

The basic components of this system are grayscale optical mark scanners (“scanners”), optical mark sense computers (OMS computers), a central system with a database containing votes (“vote database”) and a network to connect everything together.

The scanners scan the paper ballots that have been marked by the voters, producing a digital image in some media format, which we will assume to be TIFF. These digital images are transmitted to an OMS computer, which interprets the scanned image of each vote as ASCII data. This data is passed to the central system for tabulation and storage.

The markings of a voter on the ballot must be Grey-Scale Optical Mark Read (GSOMR) scannable, such as to allow a computer to determine with a high degree of accuracy the intention of the voter. Typical accuracy rates for GSOMR are 99.7% when there are erasures to interpret.

If dark ink markers are used, as in this system, precluding erasure marks, the accuracy rate will approach 100%. If a voter makes a mistaken mark, his ballot is to be cut in two with the part containing the key index placed in a secure container and he is to be given a fresh one. A count of number of discarded ballots is to be kept.

Even assuming the worst possible accuracy rate, the resulting tabulation will be accurate to within the margin of victory for most elections (0.3%). It is recommended that in the event of an election with a very narrow margin of victory (less than 0.5%), multiple scans of the ballots should be carried out to ensure determining the winner.

### The Key Index and the Printing of the Ballots

Once the number of ballots N to be printed is determined, a list of N values (“key index”) are randomly picked from the set of numbers from 1 to N1=N×M, where M is a least 100. When each paper ballot is printed, a unique key index is bar-coded onto the ballot with no accompanying printed number.

Although each paper ballot has a key index printed on it as a barcode, It would be very difficult for an individual to determine the actual index value by simply visually inspecting the ballot without a barcode scanner. Even if one were able to interpret the barcode, its value is meaningless without access to the vote database described below, thus protecting the voter's privacy.

The scarcity of the key index list amongst all possible values between 1 and N1 helps in the detection of unauthorized ballots. Without knowledge of the key index list, an attempt to inject false ballots into the system would have very little likelihood of succeeding after repeated attempts. The chance of guessing a valid key index correctly is 1:M. Assuming M equals 100, then on average, only 1 in 100 false ballots would have valid key indexes with 99 in 100 ballots having invalid key indexes. If more than just a few false ballots are introduced, the chance that they all go undetected becomes vanishing small.

The actual names of the candidates may be printed on the ballot when there is sufficient room. If there is not sufficient room, due to the number of candidates, a numbering system for identifying each candidate may be used to denote the voter's choices. If multiple sheets are needed for a single ballot, the key index must be printed on every sheet.

The number or name of the polling place shall be able to be marked on the ballot by the polling place officials if it is not already barcode printed thereon.

A random sample of sufficient size shall be taken of the printed ballots to be scanned to check for correct formatting of the ballot including legibility and correctness of the key index barcode.

During the time between the time the ballots are printed and the time they are used, they shall be kept in secure storage. After the voters mark the ballots, the ballots also shall be kept in a secure storage. Unused ballots shall be destroyed.

### The Voting Procedure

At the polling place during the time of the election, each voter is duly identified and given a single ballot as described above. That voter then proceeds to a voting station where he is expected to mark his vote on the ballot. The voter then places his vote in a scanner accessible to him or places it in a container whose contents are scanned periodically. This requires scanners and OMS computers with secure communications located at each polling place. Its advantage is the voters can see their votes being processed and lost or misplaced boxes of ballots are a thing of the past.

### The Scanning and Processing of the Ballot

The GSOMR scanner shall scan the ballots. After a pre-set number of ballots are scanned or an elapsed time has expired, the scanner transmits a file containing the scanned images to an OMS computer located at the central site, which interprets the scans. All transmissions shall be protected from error using established protocols such as TCP/IP with CRC32 or higher.

The OMS computer builds an ASCII data file containing the votes and key indexes along with any other relevant information (such as polling place name, scanner and OMS computer ids). This file is transmitted to the central system. All images are stored in files on the OMS machines able to be retrieved later. Each image is interpreted. There is a separate file for each class of interpretation, such as all candidates voted for, some but not all candidates voted for, or the wrong number of candidates voted for, or failure to interpret the key index, or invalid key index.

The interpretations of the scanned images are transmitted to the central system in ASCII data format. It places the vote along with the key index (a searchable field) and other relevant information, such as polling place, scanner and OMS computer id, into the vote database as a single record and tabulates the vote. If the key index is unreadable, a key index of zero is assigned.

In each record, there is a field for each candidate taking the value of either zero or one. If the entries on a ballot for a particular contest are properly marked, each candidate voted for is assigned a value of one, with the remaining candidates assigned a value of zero. If the entries are improperly marked, each candidate for that contest is assigned a value of zero.

A count is kept of all improperly marked contests, contests that were not fully voted for and ballots with zero, duplicate or illegitimate key indices. Each vote record shall have at least CRC32 protection. On a regular basis during the election, the vote totals are printed, to serve as a confirmation the vote totals.

### After All Votes Have Been Counted

Once the election is terminated and all votes have been entered into the vote database, the central system closes the database by entering a control record listing the number of records in the database.

It should be noted absentee ballots are to be included in the same format as regular ballots and processed in the same manner. If there is a delay in processing absentee ballots, this processing should be done using a different vote database during one period in time. It is recommended that no vote database be allowed to be open for more than 24 hours.

The printed vote totals are compared to the totals from the vote database. These numbers must match, otherwise the vote database has been corrupted and must be re-created. The CRC for each record must be verified. The printouts of the vote totals are kept as permanent records.

Reconciliation is made between the number of paper ballots given to voters and the number of records in the vote database. Reference is made to the number of votes recorded from each polling place so as to determine that no significant number of ballots have been misplaced. It will be the responsibility of the polling place to determine how many ballots have been handed out to voters. This could be done via counting the number of whole and partial boxes of ballots used minus discarded ballots. This can be only a rough guide as to how many ballots to expect from a polling place, but it will allow for the detection of wholesale unauthorized destruction of ballots.

### Determining Trustworthiness

Only by comparing the actual paper ballots to the corresponding tabulation can one determine trustworthiness. Since both the ballot and the vote record contain the key index, a ballot can be used to locate its associated record in the vote database. A ballot's key index will be called “valid” if it is contained in the vote database.

As it is not feasible to compare every ballot, a statistical approach is used. The comparison process must be done via accessing an exported copy, in a commonly accepted format, of the vote database on systems independent of the central system, using commonly accepted software. Querying the vote database directly for ballot comparison purposes is not allowed. No software produced by the voting systems provider shall reside on these independent systems. The vote totals in the exported database must agree with the central system totals.

We determine the trustworthiness of a given contest by estimating how many defective votes there are and what the effect would be if each defective vote produced the maximum effect in reversing the results of the contest. Thus we do not attempt to estimate what the effect would be if the detected defective votes were corrected.

The method is as follows. Choose a contest and let M equal one half the minimum margin of victory of winners compared to all others for that contest, but not zero. That is, M is one half the difference of the least vote count amongst all the winners less the greatest vote count amongst all the losers.

Determine a level C of confidence that is deemed acceptable to the board of elections, such as 99%. Let the number of ballots cast be B. For this contest to not be trustworthy, there must be at least M defective votes for that contest that, when made effective, will change the outcome of the contest. Choose a sample S of the ballots of size N large enough to include at least one defective vote amongst possibly M defective votes, with probability C. An upper bound for N is
log(1−C)/log((B−M)/B)

A more exact formula or a larger value of C may produce a smaller upper bound. As S is also to be used to test the reliability of the voting system, N should not be less than 1000.

For example, suppose there are 2,000,000 votes cast in a contest with one winner and three candidates with 905,000, 895,000 and 200,000 votes respectively. Let the level of confidence be 99%. Then B equals 2,000,000, C equals 0.99, M equals 5,000 (10,000/2) and N equals 1840. Thus at least 1840 paper ballots need to be compared to their corresponding records in the vote database.

In order to calculate the number of defective votes D for a contest, the procedure is as follows:

For those ballots with valid unique key indices, compare the vote on the ballot with the recorded vote in the vote database. If the two votes do not agree, then count this vote as defective. If the contest is improperly marked, the entries for those candidates in the contest should be zero in the database record. Count as defective all votes on ballots with invalid or non-unique key indices.

Calculate the ratio P of the number of defective votes D divided by N. Let U be the square root of (P×(1−P))/N. We assume that this ratio is normally distributed with a mean of P and a standard deviation U.

If P equals zero, then the contest is said to have degree of trustworthiness T equal to 1.0 with level of confidence C. If P is not zero, then the contest is said to have degree of trustworthiness T equal to the area under the normal distribution to the left of Z =1/U×(M/B−P), with level of confidence C. The degree of trustworthiness T may be converted into a percentage, in which case 1.0 is equivalent to 100%

Here is a table for T, based on our example, calculated for a range of values for D

D=0 Z=n/a T=100%

D=1 Z=3.60 T=99.98%

D=2 Z=1.84 T=96.71%

D=3 Z=0.92 T=82.12%

D=4 Z=0.30 T=61.79%

D=5 Z=−0.18 T=42.86%

D=6 Z=−0.57 T=28.43%

D=7 Z=−0.91 T=18.14%

D=8 Z=−1.20 T=11.51%

D=9 Z=−1.47 T=7.08%

D=10 Z=−1.71 T=4.36%

Suppose, after examining the sample of 1840 paper ballots, D=2 defective votes were found. Then Z=1.84 and T=96.71%. Thus this contest would be said to have degree of trustworthiness 96.71% with level of confidence 99%.

### Determining Reliability

The sample S can be used to determine the reliability of the voting system, by taking the minimum value of P as calculated for each contest.

### Public Inspection

If allowed by law, the public could be provided access to an encrypted copy of the vote database with the key indexes removed. This could be a two key public-private encryption method such as the RSA method. This database could be read but not changed. The public could then verify the accuracy of the tabulation without being able to alter the database in a believable fashion.

What is claimed is:

1. For the first time, we provide a computerized voting system for which it is possible to verify the trustworthiness of the election results via statistical methods.
